(19) United States
(12) Patent Application Publication
(10) Pub. No.: US 2006/0175739 A1
(43) Pub. Date: Aug. 10, 2006

(54) Hybrid balloon mold and method of using the mold to form a balloon that is used to manufacture a medical dilatation catheter

(75) Inventors: Gerard Hession, Co. Roscommon (IE); Donagh O'Shaughnessy, Galway (IE); Gerry Clarke, Co. Galway (IE); Seamus Ledwith, Co. Galway (IE); Michael Cummins, Co. Galway (IE); Noel Quinn, Co. Galway (IE); Ashish Varma, Galway (IE)

Correspondence Address: MEDTRONIC VASCULAR, INC.;IP LEGAL DEPARTMENT, 3576 UNOCAL PLACE, SANTA ROSA, CA, 95403, US

(73) Assignee: Medtronic Vascular, Inc., Santa Rosa, CA (US)

(21) Appl. No.: 11/053,359

(22) Filed: Feb. 8, 2005

(51) Int. Cl. A21C 11/00; B29D 22/00

(52) U.S. Cl. 264/573; 425/470

(57) ABSTRACT

A mold for forming a balloon of a balloon catheter including a body portion defining a body region of a mold cavity and distal and proximal end caps defining tapering regions and neck regions of the mold cavity. During the molding process, the mold cavity is visible from an exterior surface of the body portion, which is transparent or translucent. The distal and proximal end caps are metal and can be precision machined in the tapering and neck regions of the mold cavity in order to achieve more accurate molded balloon dimensions. Also disclosed is a method for making a balloon of a balloon catheter using the mold and a balloon made therefrom.

### FIELD OF THE INVENTION

The present invention generally relates to a method and mold for forming a balloon for a medical catheter. More particularly, the present invention relates to a hybrid mold design and method of use thereof.

### BACKGROUND OF THE INVENTION

Inflatable medical balloons associated with balloon catheters are well known in the art, and are commonly used in, for example, percutaneous transluminal coronary angioplasty (PTCA) or delivery of a vascular stent or stent graft. During a PTCA procedure, a balloon catheter is used to dilate arteries obstructed by plaque in order to improve blood flow through the artery. Stents are used as prosthetic devices to support weakened, damaged or diseased vascular walls to avoid catastrophic rupture thereof or to maintain the patency of the vessel. In stent placement procedures in coronary vessels, which often follow PTCA procedures, or in other peripheral vessels of the body, a balloon catheter may be used to radially expand and permanently position a stent within a body vessel. The balloon catheter is normally tracked through the patient's arterial system to a treatment site. The balloon catheter must typically follow a narrow and tortuous path in order to reach the desired destination. Because of the difficulty of proceeding along such a pathway during a PTCA procedure or stent delivery, the balloon is advanced through the patient's arterial system in a deflated configuration, generally folded around the catheter to as low a profile as possible.

The proper shape and size of a balloon for a balloon catheter is determined by the mold used the form the balloon and the balloon molding process. Balloon molds include a main body section, which is generally cylindrical, distal and proximal shaft sections that attach to the catheter body, and distal and proximal cone-shaped transition sections, generally called “cones,” which taper from the main body section to the distal and proximal shaft sections, respectively. The distal and proximal taper sections meet the distal and proximal shaft sections at balloon locations generally called “necks.”

The process of molding balloons for attachment to balloon catheters and for use in these procedures is well known in the art. For example, the process generally begins by placing an extruded tubular parison made of a drawable polymer having a specified diameter and wall thickness into the cavity of a mold. The parison is then heated to a blowing temperature. While in this amorphous state, the parison is pressurized so that it will expand and the parison material will be forced radially against the inner molding surfaces of the mold cavity. The parison is also drawn longitudinally distally and proximally to obtain the desired shape of the distal and proximal ends of the mold. The completed balloon is then removed from the mold.

One type of mold used to form balloons of balloon catheters is a glass mold, such as the glass mold described in U.S. Pat. No. 5,163,989 to Campbell et al., which is incorporated by reference herein in its entirety. This glass mold is formed by a labor-intensive process that includes first forming a metal core having the desired shape of the glass mold. The core is inserted into a glass tube which is then heated to shrink the glass material against the core. Once the glass has cooled, the core is then dissolved and flushed from the glass mold. Another method for forming a glass mold is similar, but involves forming a first half of the mold over the core and a second half over the core then removing the cores and, thereby avoiding the destruction of the core. These two mold halves are then heated and joined together permanently.

Each patient's vessels and obstructions reflect a specific geometry. The physician performing the procedure will choose a particular dimension balloon to use according to the geometry of the patient's vessels. If particular dimensions of the balloon are not precise, problems may occur upon inflation, deflation, or removal of the balloon, which can cause injury or irritation to delicate vascular tissue. Since precision in the dimensions of the balloon is desirable, it is important to have balloons formed from a mold with dimensional precision and accuracy.

Glass molds do not provide for balloons of good dimensional precision and accuracy because of the way the molds are produced. For example, molding glass around a core, as describe above, does not allow for measurements to be made of the interior of the mold to ensure proper mold dimensions. It also does not provide the ability to make fine adjustments to the mold to achieve precise interior dimensions. If the glass does not shrink uniformly and fittingly against the core, a balloon may have inconsistently formed cones and/or body, bumps on the body and/or an inconsistent outer diameter, which may cause malfunctions to the radial expansion of stents or improper dilation. When a mold is formed in two steps, as discussed above, separate sections often do not align properly once the mold is finally constructed. Mismatched mold portions can lead to asymmetrical tapering areas, stress lines, or other fault lines on the balloon, particularly in the tapering areas of the balloon. Also, molds are generally clamped into molding machines which apply pressure and temperature changes to the mold. Glass molds are more delicate, and strong clamping forces can not be applied to the ends of a glass molds without shattering, breaking or cracking the molds. As such, glass molds have more of a tendency to move during use, causing irregularities in the balloons.

Metal molds are also used for forming balloons of a balloon catheter. One such metal mold is described in U.S. Pat. No. 6,004,289 to Saab, which is incorporated by reference herein in its entirety. A metal mold may be very precisely machined, such as by a computer-controlled lathe. Thus, the mold can be made for narrow manufacturing specifications and tolerances. Such molds form balloons with better dimensional precision and accuracy than glass molds. Further, when metal molds are formed in two sections, the sections can be machined to fit seamlessly together. Alternatively, metal molds may be clamped tightly together to avoid forming lines on the balloon, without breaking, shattering or cracking, as glass molds would. Alternatively, the molds may have threaded portions, which can be screwed together tightly.

As discussed above, the balloon formation procedure includes loading a parison into the mold and the delicate in-process steps of expanding the parison in both radial and longitudinal directions. The transparent nature of a glass mold provides a great advantage in the balloon molding procedure because the process can be observed during the placement of the parison and during the entire molding process. As such, the set-up time and manufacturing process inaccuracies are reduced because problems during this process can be readily identified and addressed.

Metal molds, however, do not provide any visibility into the mold cavity. Loading the parison in such a mold may be difficult without visual assistance. Also, troubleshooting errors during the balloon forming process may become difficult without being able to visually detect the errors during the balloon-forming process.

### BRIEF SUMMARY OF THE INVENTION

One aspect of the present invention is directed towards a mold for forming a balloon of a balloon catheter including a transparent body portion defining a body region of a mold cavity and metal distal and proximal end caps defining tapering regions and neck regions of the mold cavity. The body portion is transparent to provide visibility into the mold cavity during the molding process. The metal distal and proximal end caps can be precision machined in the tapering and neck regions of the mold cavity in order to achieve more accurate molded balloon dimensions.

Another aspect of the present invention is a method of forming a balloon for a balloon catheter using this mold. The steps include defining a body region of a mold cavity from a transparent hollow body portion of a mold and defining distal tapering regions of a mold cavity by machining metal distal and proximal end caps. The steps also include inserting a tubular parison into the mold cavity, heating the parison, and applying pressure to radially expand the parison. The steps also include drawing the parison longitudinally to form the proximal and distal tapering sections of the balloon. The final step involves cooling the molded balloon and removing it from the mold.

Yet another aspect of the present invention is directed towards a balloon for a balloon catheter that is made using the mold and by the process of the present invention. The balloon includes a body section formed from a transparent body portion of a balloon mold, a distal tapering section formed from a metal distal portion of the balloon mold, and a proximal tapering section formed from a metal proximal portion of the balloon mold.

Further embodiments, features, and advantages of the present invention, as well as the structure and operation of the various embodiments of the present invention, are described in detail below with reference to the accompanying drawing.

### BRIEF DESCRIPTION OF THE DRAWING

The accompanying drawings, which are incorporated herein and form a part of the specification, illustrate the present invention and, together with the description, further serve to explain the principles of the invention and to enable a person skilled in the pertinent art to make and use the invention.

FIG. 1 is a cross-sectional view of an embodiment of a balloon mold of the present invention.

FIG. 2 is a cross-sectional view of portion of the balloon mold body showing a threaded embodiment.

FIG. 3 is a cross-sectional view of a portion of an end cap showing a threaded embodiment.

FIG. 4 is a flow chart illustrating a method for forming a balloon from a mold of the present invention.

The present invention will be described with reference to the accompanying drawings. The drawings in which an element first appears is typically indicated by the leftmost digit in the corresponding reference number.

### DETAILED DESCRIPTION OF THE INVENTION

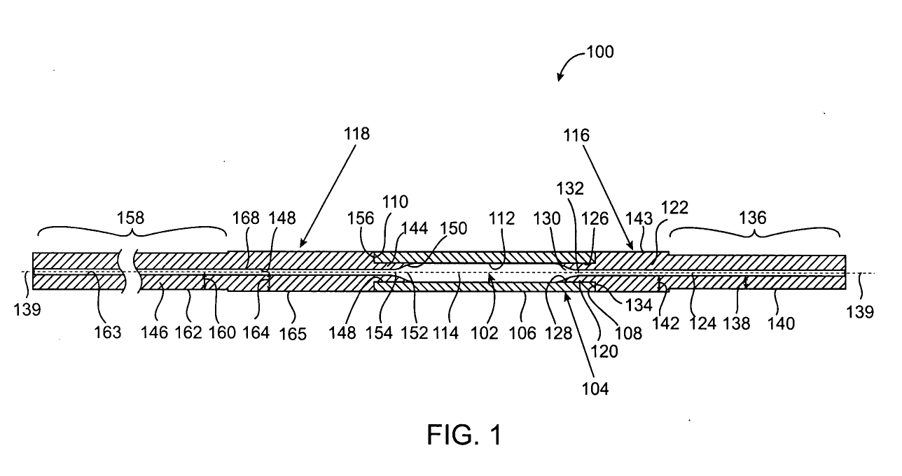

FIG. 1 is a sectional view of an embodiment of a mold 100 of the present invention. Mold 100 defines a mold cavity 102. Mold 100 is formed with a hollow body portion 104. Body portion 104 is made from a material, such as a transparent or translucent material, such that the mold cavity 102 is visible from an exterior surface 106 of body portion 104. The material may be, for example, glass. Examples of the type of glass used to form body portion 104 include, but are not limited to: borosilicate glass (commercially known under the trade name PYREX), aluminosilicate, fused silica, vitreous silica. In another embodiment, body portion 104 may be made of a plastic material, for example polyetherimide, thermoplastic polyimides (e.g. polybismaleimide polyetherimide, polyamideimide), thermosetting polyimides, polyamides, polyalkyleneterephthalates, polysulphones, polyarylesters, polyphenylenesulfides; liquid crystal polymers; polyketones e.g. polyether ether ketone, polycarbonate, polyoxymethylene; epoxide resins, unsaturated polyester resins, formaldehyde resins (e.g. melamine formaldehyde). The above-mentioned polymers may also be used with lubrication additives (used in any polymer) including PE micro-powders, fluoropolymers, silicone based oils, fluoro-ether oils, molybdenum disulphide, and polyethylene oxide and/or reinforcing additives including nano-clays, graphite, carbon fibres, glass fibres, polymeric fibres, metal fibres etc. Certain polymer materials may be machined, similarly to metals, to form a mold with high dimensional precision. Body portion 104 could be machined or moulded from such a polymer having threaded ends or designed to be press fit in place with respect to the other portions of mold 100, as discussed in detail below.

Body portion 104 has a distal end 108, a proximal end 110 and an interior surface 112 which forms a body region 114 of mold cavity 102. Body portion 104 may have a circular interior surface 112, such that a balloon formed therefrom has a generally cylindrical shape to conform to the generally cylindrical shape of body vessels. Alternatively, interior surface 112 may be prism-shaped or another shape, such as those shapes which enable the balloon to more easily inflate, deflate or fold in order to obtain low profiles. Further, an exterior surface 106 of body portion 104 may be shaped differently than as shown in FIG. 1, provided that it allows for visibility within mold cavity 102.

Unlike all-glass molds, in which the entire balloon shape must be defined by a glass mold which is difficult to accurately form, body portion 104 has a simple shape that defines just the body region 114 of mold cavity. In general, interior surface 112 of body portion 104, and thus body region 114 of mold cavity 102, will be relatively longitudinally straight, as shown in FIG. 1, to conform with the length of a body vessel. Simple glass cylinders, for example, can be made with precise sizing and consistent inner diameters, such that a body region 114 of a mold cavity 102 may have high dimensional precision.

As shown in FIG. 1, a distal end cap 116 is positioned distally to body portion 104, and proximal end cap 118 is positioned proximally to body portion 104. Distal end cap 116 and proximal end cap 118 are both formed from a metal. The metal end caps are formed using a metal that can be machined to precise dimensions, such as by a computer-controlled lathe, a laser or another precise or programmable mechanical etching or shaping device. Examples of suitable metals include, but are not limited to: titanium, stainless steel, steel, copper, brass, aluminum and alloys thereof, and the like. The caps could also be formed using a polymer material, for example polyetherimide, thermoplastic polyimides (e.g. polybismaleimide, polyetherimide, polyamideimide), thermosetting polyimides, polyamides, polyalkyleneterephthalates, polysulphones, polyarylesters, polyphenylenesulphides, liquid crystal polymers, polyketones e.g. poly ether ether ketones, polycarbonate, polyoxymethylene, epoxide resins, unsaturated polyester resins, formaldehyde resins (e.g. melamine formaldehyde). The above mentioned polymers may also be used with lubrication additives (used in any polymer) including PE micro-powders, fluoropolymers, silicone based oils, fluoro-ether oils, molybedenum disulphide and polyethylene oxide and/or reinforcing additives including nano-clays, graphite, carbon fibres, glass fibres, polymeric fibres, metal fibres etc.

Distal end cap 116 includes a distal insert portion 120 and a distal extension portion 122. Distal end cap 116 also defines a distal longitudinal bore 124 extending axially along its length. Distal insert portion 120 has an exterior surface 126 which is inserted within interior surface 112 of body portion 104 at distal end 108 thereof. To form the balloon, the mold must be heated to temperatures high enough to allows the parison positioned within the mold to change shape. As such, the metal pieces that form distal end cap 116 and proximal end cap 118 will thermally expand. In order to avoid thermal expansion forces causing the metal distal end cap 116 and proximal end cap 118 from breaking body portion 104, exterior surface 126 of distal insert portion 120 may have a slightly smaller outer diameter and be slidable with respect to an inner diameter of interior surface 112 of body portion 104 when cool.

Distal insert portion 120 has an interior surface 128, which has been machined to a precise shape to form the distal tapering region 130 of mold cavity 102. When heated, the exterior surface 126 of distal insert portion 120 expands and presses against interior surface 112 of body portion 104 to create a seamless transition between body region 114 and distal tapering region 130 of mold cavity 102. Distal tapering region 130 of mold cavity 102 communicates with longitudinal bore 124 at a distal neck region 132 of mold cavity 102.

Distal extension portion 122 includes a distal shoulder 134 which receives distal end 108 of body portion 104. There may be a gap between distal shoulder 134 and distal end 108 of body portion 104 when mold 100 is cool, to allow distal extension portion 122 to expand towards distal end 108 of body portion 104 when heated. Distal extension portion 122 may also include a bumped-down portion 136 at the distal-most end of mold 100, wherein a distance 138 from a longitudinal axis 139 of mold 100 to an outer surface 140 of bumped-down portion 136 is smaller than a distance 142 from longitudinal axis 139 of mold 100 to an outer surface 143 of the remainder of distal extension portion 122.

Proximal end cap 118 is nearly a mirror image to distal end cap 116. Proximal end cap 118 includes a proximal insert portion 144 and a proximal extension portion 146. Proximal end cap 118 also defines a proximal longitudinal bore 148 extending axially along its length. Proximal insert portion 144 has an exterior surface 148 which is inserted within interior surface 112 of body portion 104 at proximal end 110 thereof. Exterior surface 148 of proximal insert portion 144 may have a slightly smaller outer diameter and be slidable with respect to an inner diameter of interior surface 112 of body portion 104 when cool to account for thermal expansion of proximal insert portion 144.

Proximal insert portion 144 has an interior surface 150, which has been machined to a precise shape to form a proximal tapering region 152 of mold cavity 102. When heated, the exterior surface 148 of proximal insert portion 144 expands and presses against interior surface 112 of body portion 104 to create a seamless transition between body region 114 and proximal tapering region 152 of mold cavity 102. Proximal tapering region 152 of mold cavity 102 communicates with longitudinal bore 148 at a proximal neck region 154 of mold cavity 102.

Proximal extension portion 146 includes a proximal shoulder 156 which receives proximal end 110 of body portion 104. There may be a gap between proximal shoulder 156 and proximal end 110 of body portion 104 when mold 100 is cool, to allow proximal extension portion 146 to expand towards proximal end 110 of body portion 104 when heated. Proximal extension portion 146 may also include a bumped-down portion 158 at the proximal-most end of mold 100, wherein a distance 160 from longitudinal axis 139 of mold 100 to an outer surface 162 of bumped-down portion 158 is smaller than a distance 165 from longitudinal axis 139 of mold 100 to the reminder of proximal extension portion 146.

Since a balloon formed by mold 100 must be sealed to a catheter that may have a larger diameter in an area proximal to the balloon than where the balloon's body section is positioned on the catheter, it may be desirable to have mold cavity 102 be larger in this region as well. Unlike distal end cap 116, proximal end cap 118 may also include a second longitudinal bore 166 having a larger diameter than proximal longitudinal bore 148. Second longitudinal bore 166 may extend from a proximal-most end of mold 100 to an intermediate location 168 along longitudinal axis 139 of mold 100, such that second longitudinal bore 166 is coaxial to and communicates with proximal longitudinal bore 148.

Distal tapering region 130 and proximal tapering region 152 of mold cavity 102 may be conical-shaped or may have another configuration that would be suitable for ease with inflating, deflating, or folding the balloon to form a low profile. Having the distal and proximal tapering regions 130, 152 and distal and proximal neck regions 132, 154 defined by precision-machined, metal distal and proximal end caps 116, 118 provides a mold with dimensional precision, which in turn provides balloons with expected dimensions. When balloons can be molded consistently and accurately, the balloon forming process can be optimized and process controls can be utilized to make the procedure less labor intensive. Also, actual mold dimensions in the critical tapering and neck regions of mold cavity 102 can be checked readily using conventional measuring equipment.

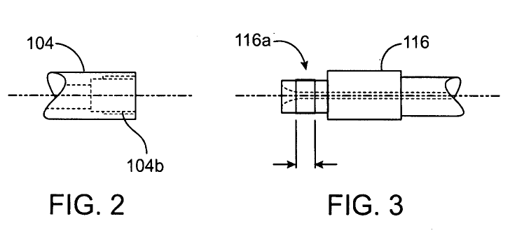

The bumped down regions 136, 158 of distal and proximal extension portions 122, 146 are provided so that strong clamping forces can be applied to distal and proximal end caps 116, 118 to hold mold 100 into a molding machine at its distal and proximal ends. In an alternate embodiment, threaded sections can be formed into distal and proximal end caps 116, 118 to secure mold 100 into place if body 104 is polymer and the end caps are metal. FIGS. 2 and 3 show threaded external surface 116a of end cap 116 and internal threads 104a of body portion 104. Being able to secure distal and proximal end caps 116, 118 to a molding machine reduces the likelihood of mold lines forming on a molded balloon from the mold moving during the molding process. The clamps may provide a metal-on-metal contact with the mold to control the thermal expansion and movement of the mold caused therefrom. Thus, the metal-on-metal contact prevents mold sections moving apart during balloon forming cycle.

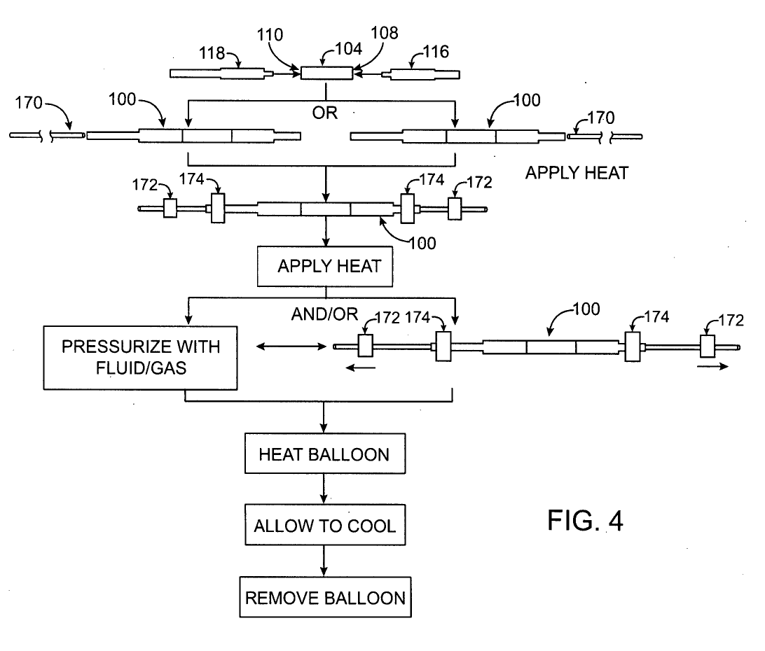

FIG. 4 illustrates a method for making a balloon using the balloon mold described or otherwise disclosed above. Once distal and proximal end caps 116,118 are positioned within distal and proximal ends 108, 110 of body portion 104, respectively, a parison 170 is inserted into mold 100. In particular, parison 170 is fed through either the distal or proximal end of mold 100 via distal longitudinal bore 124 or proximal longitudinal bore 148. Parison 170 may be a thin-walled tubular member formed from any suitable moldable and biocompatible plastic material. Particularly useful are those plastic materials which are stretchable and flexible when thin, but also strong. Examples of suitable materials include, but are not limited to: polyethylene terephthalate (PET), polyacrylenesulfide, copolyesters, polyvinyl chloride (PVC), polyurethanes, low density polyetheylenes, nylon, polyamines, polyether block amides or the like.

Distal and proximal ends of parison 170 extend out from mold 100 and are clamped into movable clamps 172 of a molding machine. Mold 100 is clamped to a non-moveable portion of the molding machine via clamps 174, such that mold 100 does not move during the molding process.

Once the molding machine set-up is complete, mold 100 and parison 170 are heated, so that parison 170 can be stretched and molded. The molding machine then injects pressurized fluids, such as nitrogen, into parison 170 to cause it to radially expand. The pressurization of parison 170 allows parison 170 to form to a body section of the balloon. However, pressurization alone does not always provide for the precision molding of the tapering sections and neck sections of the balloon. As such, the moveable molding machine clamps 172 draw parison 170 longitudinally to achieve good molding of the tapering sections and neck sections of the balloon. The longitudinal movement may occur before, after, or simultaneously with the radial expansion of parison 170, as desired. There may be another heating of the formed balloon to set the shape, before the molded balloon is allowed to cool.

Once the balloon is cooled, it is removed from the mold. For example, negative pressure could be applied to the balloon, forcing the balloon to collapse so that it can be pulled from either the proximal or distal end of said mold via distal longitudinal bore 124 or proximal longitudinal bore 148. Alternatively, the mold may be unclamped, and the balloon may be removed from the individual mold pieces, without first being deflated.

The balloon formed from a mold of the present invention will have a body section, distal and proximal tapering sections and distal and proximal neck sections that conform to body region 114, distal and proximal tapering regions 130, 152 and distal and proximal neck regions 132, 154 of mold cavity 102, respectively.

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept, spirit or scope of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one of ordinary skill in the art.

What is claimed is:

1. A mold for forming a balloon of a balloon catheter, comprising:
a body portion defining a body region of a mold cavity, said mold cavity being visible from an exterior surface of said body portion;
a distal end cap, wherein said distal end cap defines a distal tapering region of said mold cavity and a distal longitudinal bore extending from a distal end of said mold to said mold cavity; and
a proximal end cap, wherein said proximal end cap defines a proximal tapering region of said mold cavity and a proximal longitudinal bore extending from a proximal end of said mold to said mold cavity;
wherein said distal end cap and said proximal end cap are metal, polymer or ceramic

2. The mold of claim 1, wherein said body portion is transparent.

3. The mold of claim 2, wherein said body portion is glass.

4. The mold of claim 3, wherein said glass is selected from the group consisting of: borosilicate, aluminosilicate, fused silica or vitreous silica glass.

5. The mold of claim 3, wherein said glass is PYREX.

6. The mold of claim 1, wherein said body portion is plastic.

7. The mold of claim 1, wherein said body portion is translucent.

8. The mold of claim 1, wherein said distal end cap includes a distal insert portion and a distal extension portion, said distal insert portion is inserted within an interior surface of said body portion at a distal end of said body portion and defines said distal tapering region of said mold cavity, and
wherein said proximal end cap includes a proximal insert portion and a proximal extension portion, said proximal insert portion is inserted within said interior surface of said body portion at a proximal end of said body portion and defines said proximal tapering region of said mold cavity.

9. The mold of claim 8, wherein said distal extension portion of said distal end cap forms a distal shoulder for receiving a distal end of said body portion and said proximal extension portion of said proximal end cap forms a proximal shoulder for receiving a proximal end of said body portion.

10. The mold of claim 8, wherein an exterior surface of said distal extension portion includes a bumped-down outer surface at a distal-most end of said distal end cap.

11. The mold of claim 8, wherein an exterior surface of said proximal extension portion includes a bumped-down outer surface at a proximal-most end of said proximal end cap.

12. The mold of claim 1, wherein said distal longitudinal bore forms a distal neck region of said mold cavity and wherein said proximal longitudinal bore forms a proximal neck region of said mold cavity.

13. The mold of claim 1, wherein said proximal end cap includes a second longitudinal bore extending from a proximal end of said proximal end cap to an intermediate longitudinal point within said proximal end cap where said second longitudinal bore coaxially communicates with said proximal longitudinal bore, and
wherein said second longitudinal bore has a larger diameter than said proximal longitudinal bore.

14. The mold of claim 1, wherein said body region of said mold cavity is generally cylindrically-shaped.

15. The mold of claim 1, wherein said proximal and distal tapering regions are generally conically-shaped.

16. The mold of claim 1, wherein said mold cavity is visible from an exterior surface of said body portion.

17. The mold of claim 1, wherein said metal is a machinable metal.

18. The mold of claim 17, wherein said machinable metal is selected from the group consisting of: titanium, stainless steel, steel, brass, copper, and alloys thereof.

19. The mold of claim 1, wherein said distal end cap and said proximal end cap are slidably fitted within said body portion, such that thermal expansion will causes said distal end cap and said proximal end cap to seal with said body portion.

20. The mold of claim 1, further comprising: distal and proximal clamps clamped to said distal end cap and said proximal end cap.

21. A mold for forming a balloon of a balloon catheter, comprising:
a body portion having a distal end, a proximal end, an exterior surface and an interior surface, wherein said body portion defines a body region of a mold cavity and wherein said mold cavity is visible from an exterior surface of said body portion;
a distal end cap having a distal insert portion and a distal extension portion and defining a distal longitudinal bore, wherein said distal insert portion is inserted within said distal end of said body portion and slidably fitted with said interior surface of said body portion, wherein an interior surface of said distal insert portion defines a distal tapering region of said mold cavity, wherein said distal extension portion includes a distal shoulder that receives a distal end of said body portion, and wherein said distal longitudinal bore extends from said distal end of said distal end cap to a distal neck region of said mold cavity; and
a proximal end cap having a proximal insert portion and a proximal extension portion and defining a proximal longitudinal bore, wherein said proximal insert portion is inserted within said proximal end of said body portion and slidably fitted with said interior surface of said body portion, wherein an interior surface of said proximal insert portion defines a proximal tapering region of said mold cavity, wherein said proximal extension portion includes a proximal shoulder that receives a proximal end of said body portion, and wherein a proximal longitudinal bore extends from said proximal end of said proximal end cap to a proximal neck portion of said mold cavity;
wherein said distal end cap and said proximal end cap are metal.

22. The mold of claim 21, wherein said body portion is transparent.

23. The mold of claim 21, wherein said body portion is translucent.

24. The mold of claim 21, wherein said body portion is glass.

25. A balloon for a balloon catheter having a shape defined by the mold of claim 1.

26. A method of forming a balloon for a balloon catheter, comprising:
defining a body region of a mold cavity from a hollow body portion of a mold, wherein said mold cavity is visible form an exterior surface of said body portion;
defining a distal tapering region of a mold cavity by machining a metal distal end cap;
defining a proximal tapering region of a mold cavity by machining a metal proximal end cap;
inserting a tubular parison into said mold cavity;
heating said parison;
applying pressure to radially expand said parison to form a body section of said balloon;
drawing said parison longitudinally to form proximal and distal tapering sections of said balloon; and
cooling said balloon.

27. The method of claim 26, further comprising: holding said mold in place by applying a clamping force to said proximal and distal end caps.

28. The method of claim 26, wherein said machining of said distal end cap and said proximal end cap is computer-controlled.

29. The method of claim 26, wherein said transparent hollow body is a glass body.

30. The method of claim 26, further comprising the step of: defining proximal and distal neck regions of said mold cavity by forming proximal and distal longitudinal bores in said proximal and distal end caps.

31. The method of claim 26, wherein said body portion of said mold is transparent.

32. The method of claim 26, wherein said body portion is translucent.

33. The method of claim 26, wherein said body portion is glass.
